(19) United States
(12) Patent Application Publication
(10) Pub. No.: US 2025/0141203 A1
(43) Pub. Date: May 1, 2025

(54) Electronic Circuit Arrangement for Current Limitation

(71) Applicant: Siemens Aktiengesellschaft, Muenchen (DE)

(72) Inventor: Markus TROYER, Neulengbach (AT)

(21) Appl. No.: 18/730,510

(22) PCT Filed: Jan. 19, 2023
(86) PCT No.: PCT/EP2023/051280

§ 371 Date: Jul. 19, 2024

(30) Foreign Application Priority Data
Jan. 20, 2022 (EP) 22152566

(51) Int. Cl. H02H 3/02; H02H 3/00; H02H 3/05; H02H 3/087; H02H 7/00; H02H 9/02

(52) U.S. Cl. CPC H02H 3/025; H02H 3/006; H02H 3/05; H02H 3/087; H02H 7/008; H02H 9/025

(57) ABSTRACT

An electronic circuit arrangement for current limitation in a load circuit includes a power semiconductor located between a supply voltage and a load, wherein the control input of the power semiconductor is connected to the output of a controller stage and a switching contact of a circuit breaker, where a shunt resistor is inserted into the load and the voltage occurring there increases the voltage potential at the control input of the circuit breaker, a current source is also connected to the control input of the circuit breaker, where the current source generates a bias voltage at the control input of the circuit breaker via a series resistor, and where the current source has a negative temperature coefficient.

### CROSS-REFERENCE TO RELATED APPLICATIONS

This is a U.S. national stage of application No. PCT/EP2023/051280 filed 19 Jan. 2023. Priority is claimed on European Application No. 22152566.0 filed 20 Jan. 2022, the content of which is incorporated herein by reference in its entirety.

### BACKGROUND OF THE INVENTION

### 1, Field of the Invention

The invention relates to an electronic circuit arrangement for current limitation.

### 2. Description of the Related Art

In contrast to fuses or thermomagnetic trip units, electronic current limitation circuits can be designed so that the maximally occurring short-circuit current is limited. In industrial d.c. systems, especially control voltage supplies with low voltage, this short-circuit limitation is one option for ensuring the selectivity of multi-channel fuses. In particular in operation with pulsed power supplies, far less energy is available for a short-circuit compared to mains operation. One effect of this restricted availability of energy may, for example, be a collapse in the supply voltage, so that a fault in one channel affects the entire system. In order to increase system availability, circuits have hence been developed with the purpose of limiting the maximally occurring short-circuit current (linearly limiting electronic fuses) or else of reducing the short-circuit duration (switching electronic fuses).

In practice, electronic fuses have become established as “HighSide” switches, because it is normal in systems to use a common ground and to connect the loads thereto in a single-pole manner. Thus, only the positive supply voltage remains for protection. This means that the power component is switched between the power supply and the load for linear limitation or shutdown. Particular attention should be paid here to the avoidance of excessive power loss in the limitation elements, such as transistors that are used as switching elements.

The advantage of linearly limiting circuits is that the current can be defined in any overload situation. Disadvantages are the complex circuitry and the associated costs. In contrast, the advantage of switching topologies is reduced circuitry, because the treatment of overload currents is largely assumed by a microcontroller (uC) and/or integrated in IC components, such as within components of the type BTS6143 from Infineon.

The disadvantage of these circuits is the inherent trip delay, which can result in an undefined overload current. In extreme situations, such as short-circuits, the short-circuit currents that occur can cause undesired effects, with consequences for the entire system.

It is hence expedient to link the advantages of the definable short-circuit current of the linearly limiting topologies to the advantages of switching devices.

One approach is, as in limiting circuits, to switch a power transistor, such as a MOSFET, from continuous conduction mode to linear mode when an adjustable power threshold is exceeded and to limit the short-circuit current or overload current that occurs in a controlled manner.

In contrast to limiting circuits, the short-circuit or the overload are limited only for a short duration. The limitation of the current and the reduction in the duration in time represent less stress for the power semiconductor and are adjusted to the Safe Operating Area (SOA) of the power semiconductor so overheating inside the semiconductor that exceeds the maximum permitted temperature of the semiconductor cannot occur. Thus, compared to the conventional circuits described in WO 2002 082611 A2, it is possible to dispense with additional measures such as a parallel branch along with a power resistor, as a result of which the circuitry is considerably reduced.

Dispensing with limiting passive components, such as the power resistor in the parallel branch and the associated switching mechanisms, imposes certain requirements on the control circuit.

Power semiconductors such as MOSFETs have very low impedances in continuous conduction mode and cause very low losses.

Due to the low-impedance transistors, unforeseeable overload events, such as a short-circuit very quickly, cause high currents that can destroy the power component, where the limitation mode only starts with a time delay in the range of several 100 ns or in the us range.

To prevent this, the controllers must respond very quickly to such faults, in order to switch to limitation mode in good time, without the power semiconductor being damaged.

In practice, designing the controller and the semiconductor appropriately poses a challenge. On the one hand, control circuits are typically constructed using operational amplifiers, which do not permit instant response times.

Furthermore, power semiconductors suitable for linear mode have comparatively slow switching times, as a result of which further delays can occur in the response to short-circuit events. The resultant inertia means that the power semiconductor is at risk of overload, or else the aim of limiting the short-circuit current and avoiding repercussions on the system is missed.

In order to keep the requirements on the control circuit low, it is known for a peak value of the short-circuit current l_{KS,max} to be permitted for a short duration, typically <10 μs, at the moment of occurrence of the short circuit, so that there is no significant impact on the system, since the energy can, for example, be made available to the power supply from the capacitors (usually electrolytic capacitors).

The current is then reduced to an adjustable value (typically 1, 5 . . . 2 I_{Nom}) and is consistently limited by the controller. In order not to endanger the transistor in this operating state, in accordance with the SOA of the semiconductor, a switch-off takes place, after a hold time of a few ms in linear mode, by a higher-level monitoring device, such as a microcontroller.

In this case, it is difficult if not impossible to prevent the occurrence of a peak value of the short-circuit current using reasonably required circuitry.

Hence, it is necessary to extend the control of the transistor to include circuit parts that compensate for the limited responsiveness of the operational amplifier and the associated control circuit. From the literature (Tietze, Schenk; “Halbleiter Schaltungstechnik” [Semiconductor circuit technology], Springer Verlag), short-circuit protective circuits or overload protective circuits based on diodes or bipolar transistors (BJT) are known for power semiconductors, but in practice these have certain shortcomings, so that they can only be used under certain conditions. The principle of these protective circuits is based on the fact that a current-proportional voltage is tapped at a measuring resistor (shunt) located at the circuit output, so that when a threshold voltage is exceeded (usually an integer multiple of 0.7 V for silicon semiconductors), the control signal of the power component (base current for BJT, or gate-source voltage for FET) is short-circuited.

In this case, the dimensioning of these protective circuits poses a challenge, because the measurement resistors needed for this must be selected to be low-impedance at the circuit output, in order to keep the power loss within limits. Values in the mΩ range are desirable here, but are disadvantageous for the design of the protective circuit.

Because of the low-impedance measuring resistor, relatively high currents are necessary in order to achieve the threshold voltages necessary to trip the protective circuit. When constructing the protective circuit with bipolar transistors, this circumstance can be countered by a bias voltage. As a result, the voltage drop across the measuring resistor necessary in order to reach the trip threshold is significantly reduced. In this approach, the temperature dependence comes to the fore to a large extent. The threshold voltage of silicon semiconductors decreases with −2 mV/K, so that the trip threshold of the protective circuit also decreases. At high operating temperatures, this can result in a premature intervention and undesired effects, even leading to the destruction of the power semiconductor, for instance, because the current limitation already intervenes in normal continuous conduction mode and the transistor builds up an unnecessary voltage drop and thus a high continuous power loss, for which the cooling is not designed. In addition, in a design favorable for high operating temperatures (60° C.), there is a risk that the power semiconductor is not sufficiently protected at low operating temperatures (<<25° C.), because it is limited to currents that are much too high, resulting in overheating in the semiconductor even after only a very short period of operation. Furthermore, effects are known in which the semiconductor crystal can break due to mechanical stress in the case of high, fast temperature rises.

### SUMMARY OF THE INVENTION

In view of the foregoing, it is therefore an object of the invention to provide a circuit with which overload currents can be limited to a predefinable value, and with which the peak occurring value of the short-circuit current (l_{KS,max}) can be limited in a predefined manner and in a manner that tracks the operating temperature.

These and other objects and advantage are achieved in accordance with the invention by an electronic fuse having a power semiconductor arranged between a supply voltage and a load, where the control input of power semiconductor is connected to the output of a controller stage and a switching contact of a circuit breaker, where a shunt resistor is inserted into the load circuit and the voltage occurring there increases the voltage potential at the control input of the circuit breaker, where a current source is further connected to the control input of the circuit breaker, the current source generating a bias voltage at the control input of the circuit breaker via a series resistor (R2), and where the current source has a negative temperature coefficient.

One advantage of the inventive arrangement lies in the improved response behavior of the electronic fuse compared to conventional switching designs and at the same time in reduced complexity compared to limiting electronic fuses. In switching electronic fuses, the maximum short-circuit current is limited by parasitic ohmic resistances (e.g., copper cable, RDS (on) of the FET, ohmic losses fuse, and/or short-circuit impedance). Such high current peaks cause repercussions on the underlying system, including the power supply, so that under unfavorable circumstances the system may be impaired. Selectivity in the event of a fault cannot be guaranteed under all circumstances. Such repercussions are avoided by limiting the short-circuit peak value I_{KS,max}.

Particularly advantageous here is temperature tracking of the trip thresholds. This permits secure operation over a wide temperature range and circumvents difficulties in the design of the conventional approaches.

Owing to linear limitation, overloading of the supply sources is ruled out, as a result of which use with underperforming power supplies is possible.

The linear limitation is reduced to a few ms. As a result, the circuit can be made to be significantly simpler than known limiting topologies. At the same time, the performance of the power transistor M1 can be fully exploited, without unnecessary overdimensioning which, especially in the case of transistors in linear mode, is only possible via very large chip surfaces and low thermal transfer resistances to the housing (leadframe) and massively restricts the selection of transistors.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in greater detail on the basis of figures, in which by way of example:

FIG. 1 shows a first advantageous exemplary embodiment of the inventive circuit arrangement; and

FIG. 2 shows an inventive circuit arrangement in accordance with a second advantageous exemplary embodiment.

### DETAILED DESCRIPTION OF THE EXEMPLARY EMBODIMENTS

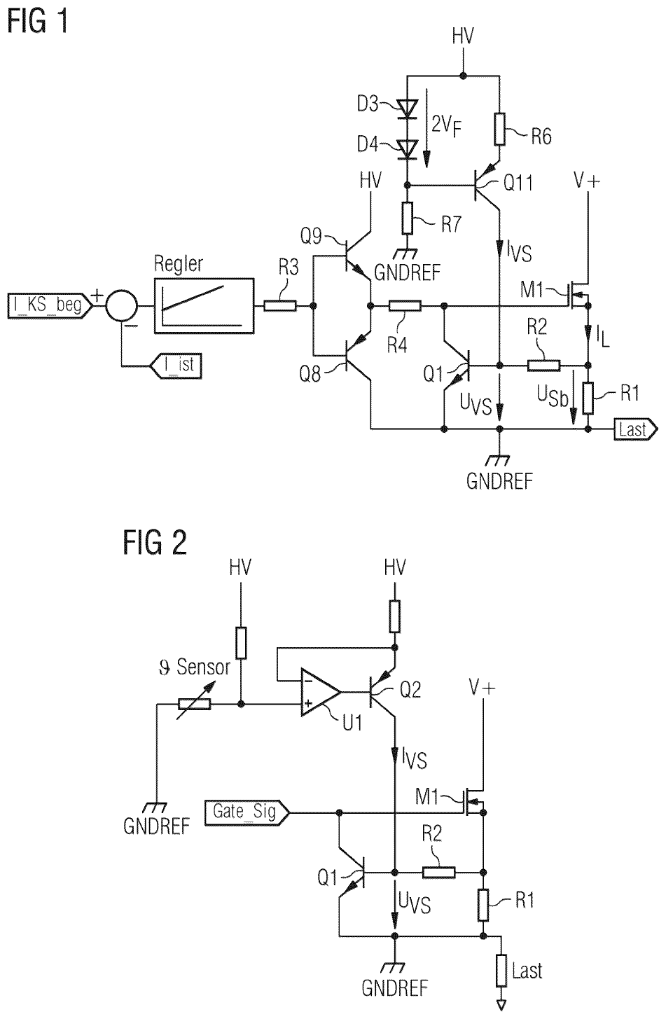

The circuit arrangement as illustrated in FIG. 1 comprises a power semiconductor M1 arranged between a supply voltage V+ and a load, i.e. in a load circuit, preferably in the embodiment as an n-channel metal oxide semiconductor field effect transistor (n-channel MOSFET), where the control input (gate) of the power semiconductor M1 is connected to the output of a controller stage (RS) and a switching contact of a circuit breaker Q1. In the present exemplary embodiment, a silicon bipolar transistor is provided as a circuit breaker. Additionally, a shunt resistor R1 is inserted into the load circuit between the source connection of the MOSFET and the load. The voltage U_{Sh} occurring there (across the shunt resistor R1) increases the voltage potential at the control input (the base) of the circuit breaker Q1.

The exemplary embodiment further comprises a current source SQ, which via a series resistor R2 generates a bias voltage at the control input, the base of the circuit breaker Q1, and has a negative temperature coefficient, so that the bias voltage at the base of the circuit breaker Q1 also has a negative temperature coefficient.

The current source SQ is formed by a semiconductor switch Q11, for example, a further bipolar transistor, the voltage potential of which is formed at the control input (base) in a temperature-dependent manner via a voltage divider formed from diodes D3, D4 and a further resistor R7.

It should be understood here that the threshold voltage of a silicon diode behaves similarly with changes in temperature as the base emitter path of a silicon bipolar transistor. Hence, if the diodes D3, D4 of the current source SQ are thermally well connected to the circuit breaker Q1, then a thermally similar behavior can be expected.

The serially switched diodes D3 and D4 of the current source serve as a voltage reference for the specified current I_{VS} in accordance with the relationship:

$${I}_{VS} = \frac{2 {V}_{F} - {U}_{BE , Q 11}}{R 6} \qquad Eq . 1$$

where V_{F} is the voltage dropping across the diodes D3 and D4, U_{BE,Q11} is the base emitter voltage of the further semiconductor switch Q11 and R6 is the collector resistance of the further semiconductor switch Q11.

This specified current I_{VS} flows via series resistor R2 and shunt resistor R1 and generates the bias voltage U_{VS} at the base of the circuit breaker Q1. By appropriate dimensioning of the series resistor R2, the bias voltage can, assuming R2>>R1, be specified in a good approximation in accordance with the relationship:

$${U}_{VS} = {I}_{VS} \cdot R 2 \qquad Eq . 2$$

and thus the necessary load current IL through the power semiconductor M1 to reach the threshold voltage for current limitation I_{KS,max} can be set. When the threshold voltage is reached, the circuit breaker Q1 becomes conductive and the control signal of the power semiconductor M1 is short-circuited.

The threshold voltage of the protective transistor Q1, for example, formed as a bipolar junction transistor (BJT), is furthermore temperature-dependent and decreases with −2 mV/K as the temperature rises. With appropriate thermal coupling of Q1, Q11, D3 and D4, it should be understood that all have the same component temperature or at least the same temperature increase during operation. All the relevant components are silicon components. Consequently, they all have the same temperature drift of −2 mV/K. In accordance with the equation for the constant current I_{VS}, the temperature drift of Q11 with −2 mV/K is overcompensated for by 2VF with −4 mV/K. As a result, the current I_{VS} decreases as the temperature increases, i.e., with appropriate dimensioning of the base resistor R2, the bias voltage U_{VS} also decreases. The decrease in the trip threshold of the protective transistor Q1 is thereby compensated for. The principle of the controlled current source for adjusting the trip threshold of the short-circuit current limitation can be extended to other operating situations. The controller and the control accessory can be adapted to different operating conditions so that different trip characteristics can be specified, whereby the SOA of the power semiconductor specifies the load limits. By adjusting the setpoint for the limitation current I_{KS,lim} and the specified current I_{VS}, an adjustment is possible during operation. This allows various detection, test or commissioning scenarios to be implemented.

A further advantageous form of embodiment of the invention is shown in FIG. 2. Here, the current source SQ with a negative temperature coefficient comprises a temperature sensor, via which a voltage signal is supplied to an operational amplifier, which in turn controls a semiconductor switch.

In principle, other configurations of temperature-controlled power sources are also conceivable for the inventive solution. The only essential thing is that the unavoidable temperature dependence of the current through the protective contact and of the control input of the circuit breaker Q1 is compensated for via a current source SQ that generates a bias voltage at the control input of the circuit breaker Q1 via a network of resistors and temperature-dependent semiconductors D1, D2 and has a temperature coefficient that counteracts the temperature dependence of the at least one semiconductor used as a protective contact and results in a substantially thermally non-dependent response of the circuit breaker.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements that perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-4. (canceled)

5. An electronic circuit arrangement for current limitation in a load circuit, comprising:
a controller stage;
a power semiconductor arranged between a supply voltage and a load, a control input of said power semiconductor being connected to an output of the controller stage and a switching contact of a circuit breaker;
a shunt resistor inserted into the load, a voltage occurring in the shunt resistor increasing a voltage potential at a control input of the circuit breaker; and
a current source connected to the control input of the circuit breaker, said current source generating a bias voltage at the control input of the circuit breaker via a series resistor;
wherein the current source has a negative temperature coefficient.

6. The electronic circuit arrangement as claimed in claim 5, wherein the power semiconductor comprises a metal oxide semiconductor field effect transistor.

7. The electronic circuit arrangement as claimed in claim 5, wherein the current source comprises a semiconductor switch having a potential which is established at the control input via a temperature-dependent voltage divider.

8. The electronic circuit arrangement as claimed in claim 6, wherein the current source comprises a semiconductor switch having a potential which is established at the control input via a temperature-dependent voltage divider.

9. The electronic circuit arrangement as claimed in claim 5, wherein the current source comprises a semiconductor switch having a voltage potential which is formed at the control input in a temperature-dependent manner via a voltage divider formed from diodes and resistors.

10. The electronic circuit arrangement as claimed in claim 6, wherein the current source comprises a semiconductor switch having a voltage potential which is formed at the control input in a temperature-dependent manner via a voltage divider formed from diodes and resistors.
